(19) United States
(12) Patent Application Publication
(10) Pub. No.: US 2026/0097800 A1
(43) Pub. Date: Apr. 9, 2026

(54) Folding Wagon Convertible to Chair

(71) Applicant: Sunderwell Corporation, San Bernardino, CA (US)

(72) Inventor: Ping Li, Chino Hills, CA (US)

(21) Appl. No.: 18/910,624

(22) Filed: Oct. 9, 2024

(51) Int. Cl. B62B 3/02; A47C 1/14; A47C 13/00; B62B 3/00

(52) U.S. Cl. CPC B62B 3/02; A47C 13/00; B62B 3/002; A47C 1/14; B62B 2206/006

(57) ABSTRACT

A convertible wagon includes a frame including a bottom element, side frame elements, a front frame element, and a rear frame element. The bottom element is extensible in a flat configuration and foldable along a transversal section in a folded configuration. The front frame element includes connectors connectable to the side frame elements to form a front wagon side in a wagon configuration. The connector can be disconnectable from the side frame elements to form a chair foot support portion at a level of the bottom element in a chair configuration. The rear frame element is connected to the bottom element, the first side frame element, and the second side frame element. A fabric is extended between the front frame element and the rear frame element. The sides of the fabric are extensible over the side frame elements or can be foldable over the bottom element.

### TECHNICAL FIELD

The present disclosure generally applies to convertible wagon designs and more particularly to folding wagons convertible to chairs.

### BACKGROUND

Folding chairs have been used to provide temporary seating during extended events organized in open fields. The design of portable folding chairs has changed to increase the comfort of the user, especially in circumstances of extended seating time. For example, some folding chairs include a layer of padding and improved back support. Some folding chairs minimized the comfort for enhancing storage space. For instance, the frames of folding chairs are often simplified to reduce weight and bulk, which can compromise stability and comfort. Features that enhance comfort, such as adjustable backrests or reclining options, are usually omitted to keep the design of folding chairs simple and compact. Independent of the storage to comfort ratio of folding chairs, such chairs are generally configured to be carried over a particular distance, adding to a weight of other items intended for use at the set location.

### SUMMARY

Implementations of the present disclosure are directed to convertible wagon chair designs. More particularly, implementations of the present disclosure are directed to folding wagons convertible to chairs.

The present disclosure provides a convertible wagon, including: a frame including: a bottom element extensible in a flat configuration and foldable along a transversal section in a folded configuration, a first side frame element, a second side frame element, a front frame element including a first connector and a second connector, the first connector connectable to the first side frame element and the second connector connectable to the second side frame element to form a front wagon side in a wagon configuration, the first connector being disconnectable from the first side frame element and the second connector being disconnectable from the second side frame element to form a chair foot support portion at a level of the bottom element in a chair configuration, and a rear frame element connected to the bottom element, the first side frame element, and the second side frame element, and a fabric extending between the front frame element and the rear frame element, wherein sides of the fabric are extensible over the first side frame element and the second side frame element to define lateral wagon sides in the wagon configuration and are foldable over the bottom element in the chair configuration.

It is appreciated that convertible wagon in accordance with the present disclosure can include any combination of the aspects and features following described. The rear frame element includes a first coupling element connectable to the first side frame element and a second coupling element connectable to the second side frame element to form a rear wagon side in the wagon configuration and a back support portion in the chair configuration, the back support portion in the chair configuration forming a first angle with the bottom element. The first coupling element is disconnectable from the first side frame element and the second coupling element is disconnectable from the second side frame element to form a second angle between the back support portion in the chair configuration and the bottom element. The first angle is a substantially straight angle, and the second angle is a substantially obtuse angle. Each of the first coupling element and the second coupling element includes a hooked end clasping around vertical bars of each of the first side frame element and the second side frame element. Each of the first side frame element and the second side frame element includes a substantially horizontal bar and an angled bar connected to the substantially horizontal bar and a side margin of the bottom element. The substantially horizontal bar and the angled bar are pivotably connected to each other to form a substantially obtuse side angle in the chair configuration and in the wagon configuration and to form a substantially acute side angle in the folded configuration. The bottom element includes a pulling element for transitioning the convertible wagon from the wagon configuration to the folded configuration. The fabric includes releasable connections along the sides to attach the fabric to the first side frame element and to the second side frame element in the wagon configuration and detach the fabric for the chair configuration. The front frame element includes a handle in the wagon configuration that functions as a leg in the chair configuration. The rear frame element includes a handle in the wagon configuration that functions as a back support leg in the chair configuration. The convertible wagon further including a strap connector including a first portion attached to the front frame element and a second portion attached to the rear frame element, the strap connector including the first portion attached to the second portion holding the convertible wagon in the folded configuration, the first portion being detached from the second portion in the chair configuration and in the wagon configuration. The fabric includes any of a polyester fabric, a nylon fabric, a polypropylene fabric, an acrylic fabric, textilene fabric and a sunbrella fabric.

The present disclosure further provides a method of configuring a convertible wagon, including: disconnecting a strap connector of a convertible wagon to transition from a folded configuration to a wagon configuration, the convertible wagon including: a frame including: a bottom element extensible in a flat configuration and foldable along a transversal section in a folded configuration, a first side frame element, a second side frame element, a front frame element including a first connector and a second connector, the first connector connectable to the first side frame element and the second connector connectable to the second side frame element to form a front wagon side in a wagon configuration, the first connector being disconnectable from the first side frame element and the second connector being disconnectable from the second side frame element to form a chair foot support portion at a level of the bottom element in a chair configuration, and a rear frame element connected to the bottom element, the first side frame element, and the second side frame element, and a fabric extending between the front frame element and the rear frame element, wherein sides of the fabric are extensible over the first side frame element and the second side frame element to define lateral wagon sides in the wagon configuration and are foldable over the bottom element in the chair configuration.

The present disclosure further provides a method of configuring a convertible wagon, including, for example: disconnecting a first connector and a second connector of a convertible wagon to transition from a wagon configuration to a chair configuration, the convertible wagon including: a frame including: a bottom element extensible in a flat configuration and foldable along a transversal section in a folded configuration, a first side frame element, a second side frame element, a front frame element including the first connector and the second connector, the first connector connectable to the first side frame element and the second connector connectable to the second side frame element to form a front wagon side in the wagon configuration, the first connector being disconnectable from the first side frame element and the second connector being disconnectable from the second side frame element to form a chair foot support portion substantially at a level of the bottom element in the chair configuration, and a rear frame element connected to the bottom element, the first side frame element, and the second side frame element, and a fabric extending between the front frame element and the rear frame element, wherein sides of the fabric are extensible over the first side frame element and the second side frame element to define lateral wagon sides in the wagon configuration and are foldable over the bottom element in the chair configuration.

It is appreciated that methods in accordance with the present disclosure can include any combination of the aspects and features described herein, including the following. The method of configuring a convertible wagon further includes: disconnecting a first coupling element of the rear frame element from the first side frame element and disconnecting a second coupling element of the rear frame element from the second side frame element to modify an angle of a back support portion in the chair configuration. The method of configuring a convertible wagon further includes: connecting the first coupling element of the rear frame element to the first side frame element and connecting a second coupling element of the rear frame element to the second side frame element to fix the back support portion in a substantially vertical position. Each of the first coupling element and the second coupling element includes a hooked end clasping around vertical bars of each of the first side frame element and the second side frame element. The methods in accordance with the present disclosure are not limited to the combinations of aspects and features described herein, but also include any combination of the aspects and features provided.

Implementations described in the present disclosure, provide numerous advantages, enhancing safety, and efficiency of convertible wagon chairs. One of the advantages provided by the convertible wagon chairs described herein includes versatility. For example, the convertible wagon chairs provides a multi-functional use. The convertible wagon chair can convert into a comfortable chair or other resting place, such as a cot, providing dual functionality for various activities, such as camping, beach outings, picnics, and sports events. The transition between wagon and chair modes is simple and quick, with minimal effort and without the need for additional tools. Another advantage provided by the convertible wagon chairs described herein includes portability. The convertible wagon chair can be used as a wagon for facilitating the transport of multiple items and can fold into a compact size for easy storage, fitting into car trunks or small storage spaces. Despite its durability, the described convertible wagon chairs are lightweight and include wheels for facilitating carrying and maneuvering in any configuration. For example, when in wagon mode, the described convertible wagon chairs provide ample space to carry a variety of items, including coolers, sports equipment, or camping gear. Another advantage provided by the convertible wagon chairs described herein includes a stable design. The convertible wagon chair includes a stable base to prevent tipping over, both in wagon and chair configurations. Another advantage provided by the convertible wagon chairs described herein includes secure locking mechanisms. The convertible wagon chair includes reliable locking mechanisms to ensure the wagon stays securely in place when converted to a chair.

Additional features and advantages of the invention are set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims or may be learned by the practice of the invention as set forth hereinafter.

### DESCRIPTION OF DRAWINGS

FIG. 1A illustrates an example of a convertible wagon chair in a chair configuration having a fabric covering a frame, according to some implementations of the present disclosure.

FIG. 1B illustrates an example of a convertible wagon chair frame in a chair configuration having the back at a first angle, according to some implementations of the present disclosure.

FIG. 1C illustrates an example of a convertible wagon chair frame in a chair configuration having a rear frame element at a second angle and having a handle at a first angle, according to some implementations of the present disclosure.

FIG. 1D illustrates an example of a convertible wagon chair frame in a chair configuration having a rear frame element at a second angle and having the handle at a second angle, according to some implementations of the present disclosure.

FIG. 2A illustrates an example of a convertible wagon chair in a wagon configuration having a fabric covering the frame, according to some implementations of the present disclosure.

FIG. 2B illustrates an example of a convertible wagon chair frame in a wagon configuration, according to some implementations of the present disclosure.

FIG. 3 shows an example of a partly folded convertible wagon chair transitioning from a wagon configuration to a folded configuration, according to some implementations of the present disclosure.

FIG. 4A illustrates an example of a convertible wagon chair in a folded configuration having a fabric covering the frame, according to some implementations of the present disclosure.

FIG. 4B illustrates an example of a convertible wagon chair frame in a folded configuration, according to some implementations of the present disclosure.

FIG. 5A is a flowchart of an example of a method for opening a folded convertible wagon chair for forming a wagon, according to some implementations of the present disclosure.

FIG. 5B is a flowchart of an example of a method for forming a chair from a wagon, according to some implementations of the present disclosure.

FIG. 5C is a flowchart of an example of a method for folding a convertible wagon chair into a folded configuration, according to some implementations of the present disclosure.

Like reference numbers and designations in the various drawings indicate like elements.

### DETAILED DESCRIPTION

The following detailed description describes convertible wagon chair designs. More particularly, implementations of the present disclosure are directed to foldable wagons convertible to chairs. The described implementations provide an item that can be arranged as a wagon that can be converted into a chair or can folded for storage. The convertible wagon chair includes a frame with a bottom part that can lie flat or fold in half. The convertible wagon chair includes two side frame parts that can function as arm rest and a front frame part with two connectors. The connectors can connect to the side frames to form a front of the wagon. The connectors can also disconnect from the side frames to create a footrest when the convertible wagon chair is used as a chair. The convertible wagon chair includes a rear frame part connected to the bottom and side frames. The convertible wagon chair includes a material that stretches between the front and rear frames. The material can cover the sides to form the wagon or fold over the bottom when making a chair.

Addressing limitations of portable chairs, the described convertible wagon chair facilitates conversion from a chair to a wagon facilitating safe transportation of items across land, including rough terrains, such as dirt roads or grassy areas. The convertible wagon chair designed and constructed for outdoor conditions. The convertible wagon chair can include lightweight, durable, and eco-friendly materials including a fabric covering at least a portion of a frame that can be designed to provide comfort to a user.

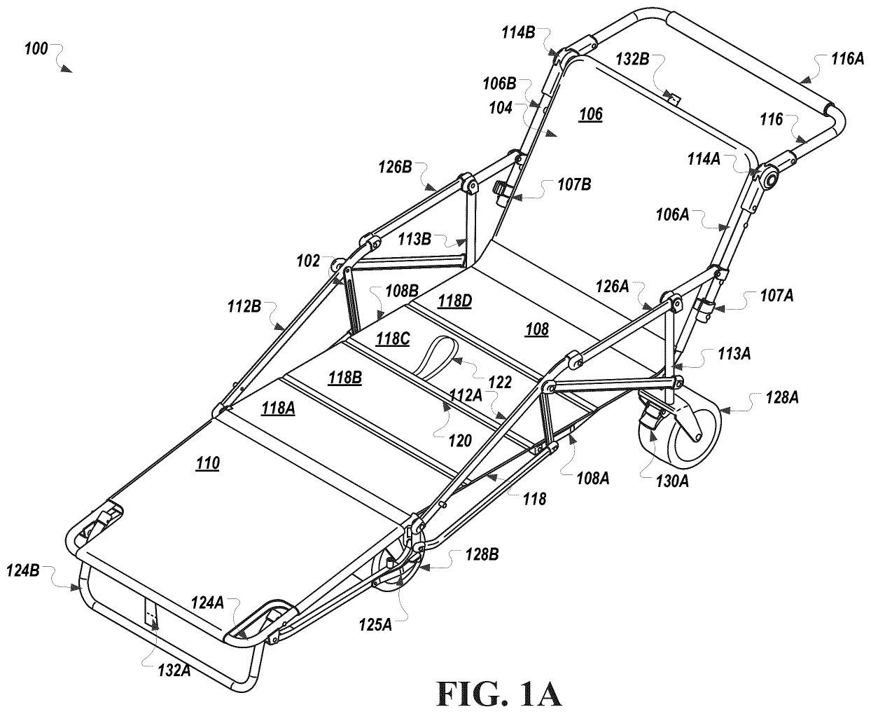

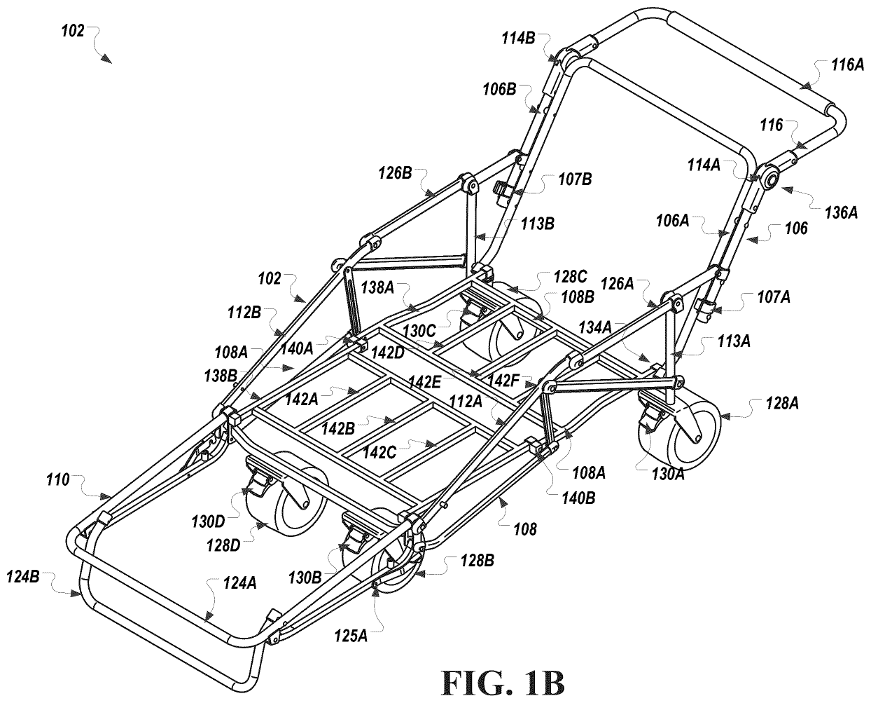

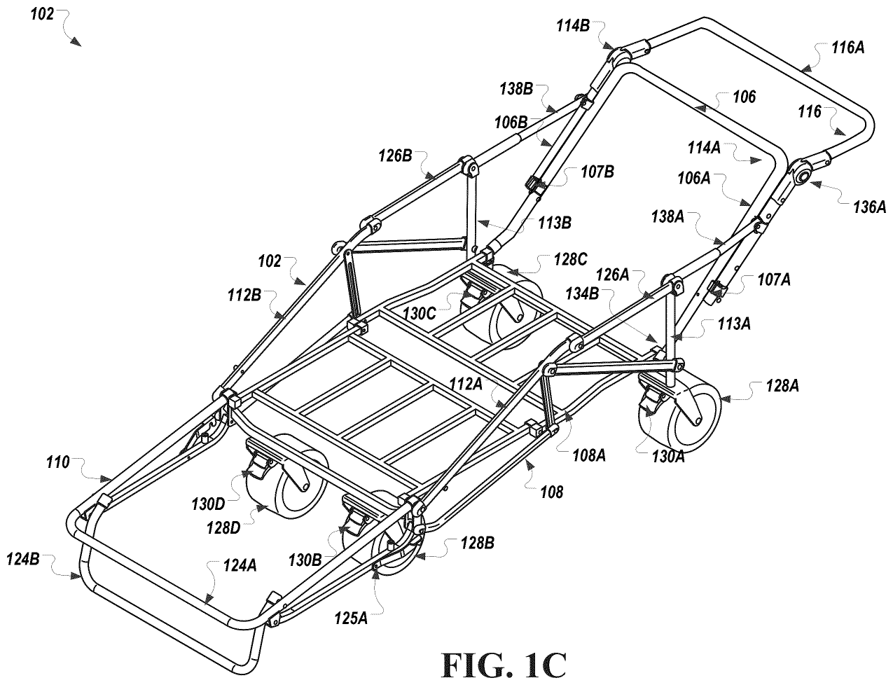

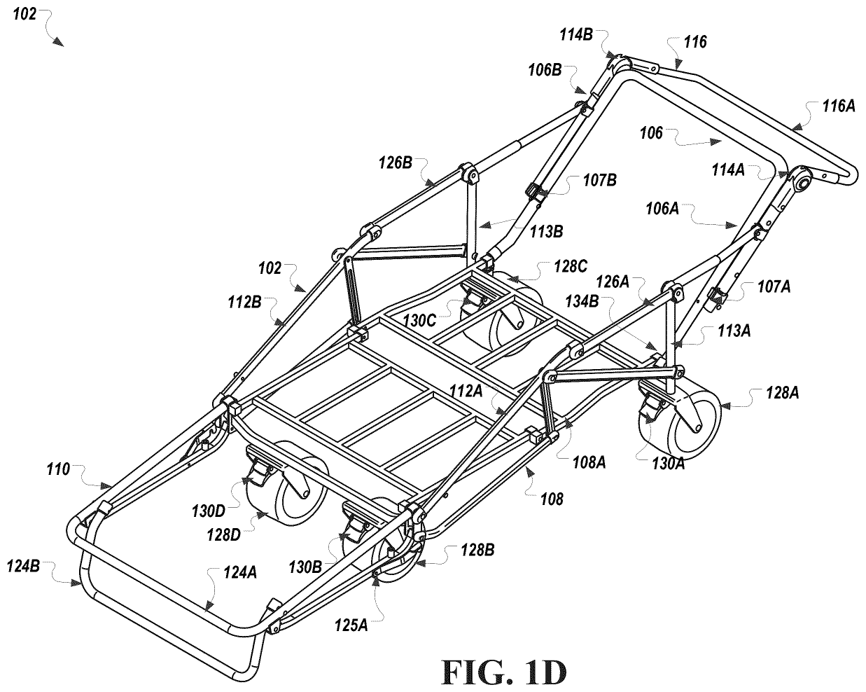

FIG. 1A illustrates an example of a convertible wagon chair 100A in a chair configuration having a frame102 covered by a fabric 104, according to some implementations of the present disclosure.

The fabric 104 can cover a portion of any of a rear frame element 106, a bottom element 108, and a front frame element 110, a first side frame element 112A, and a second side frame element 112B. In the chair configuration, the fabric 104 covers a portion of the rear frame element 106, the bottom element 108, and a portion of the front frame element 110. The fabric 104 includes any ultra-violet resistant textile and/or weather resistant textile, such as a polyester fabric, a nylon fabric, a polypropylene fabric, an acrylic fabric, textilene fabric and a sunbrella fabric.

The rear frame element 106 defines a back portion in the chair configuration. The rear frame element 106 is connected to the bottom element 108, the first side frame element 112A, and the second side frame element 112B. The rear frame element 106 includes joints 114A, 114B for supporting a rotatable handle 116. The rotatable handle 116 can be fixed in a substantially horizontal position for maneuvering the convertible wagon chair 100A. The rotatable handle 116 can be fixed in an acute position to further support of the rear frame element 106 to prevent the convertible wagon chair 100 from tipping over by functioning as a leg or a stand in the chair configuration. The rotatable handle 116 can include a protection layer, such as a wrap or a grip. The protection layer can be made of materials including foam, rubber, or silicone to wrap around the handle to provide improved cushioning and grip. The back support fabric 104 can extend from the sides 106A, 106B of the rear frame element 106. Each of the sides 106A, 106B of the rear frame element 106 includes a coupling element 107A, 107B connectable to a respective side frame element 112A, 112B. The coupling elements 107A, 107B can include a clip, a sleeve, a ring, or any other type of coupling element that facilitates temporary attachment to and detachment of the sides 106A, 106B of the rear frame element 106 from rear support side bars 113 A, 113B that can be in a substantially vertical position in the chair and wagon configurations. The coupling elements 107A, 107B can be made of plastic or metal facilitating stability and ease of connection and disconnection.

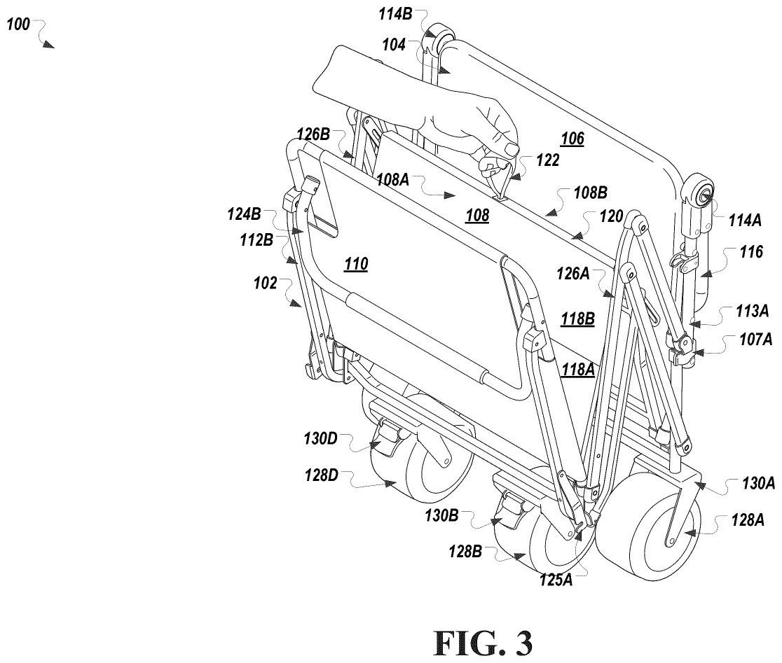

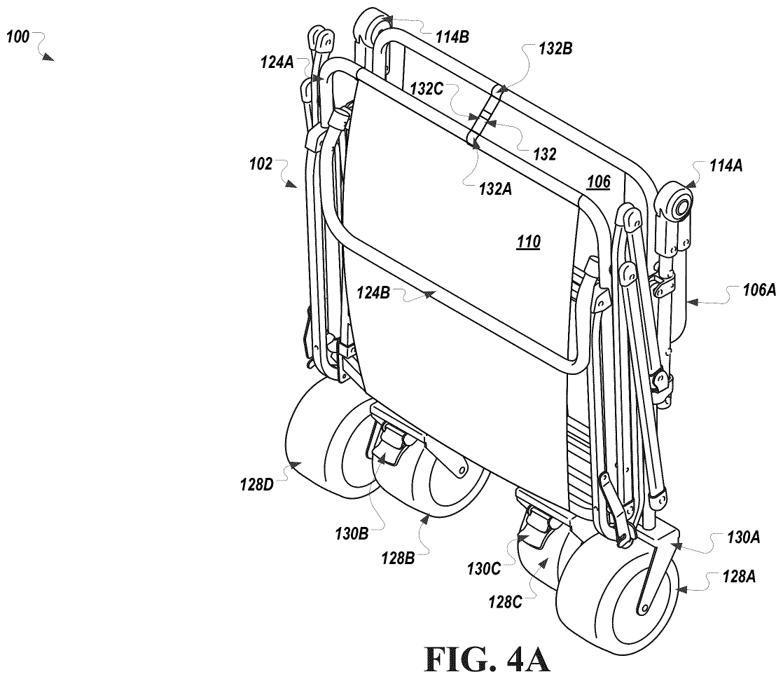

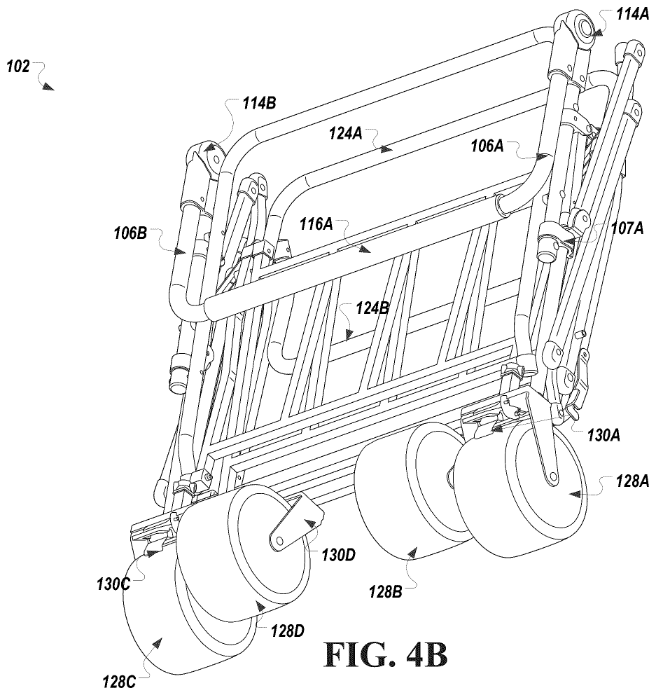

The bottom element 108 defines a chassis of the convertible wagon chair 100A, providing a seat support portion in the chair configuration. The bottom element 108 can include a reinforced rigid material 118 being covered by the fabric 104 and extending from the side margins 108A, 108B of the bottom element 108. The reinforced rigid material 118 can be sectioned in multiple portions, including two or more portions 118A, 118B symmetrically distributed around a transversal axis 120 of the bottom element 108 to enable folding the bottom element 108 when folding the example convertible wagon chair 100, as shown in FIGS. 3, 4A and 4B. The bottom element 108 includes a pulling element 122 (e.g., pulling loop or pulling tab). In some implementations, the pulling element 122 is attached substantially to a middle portion of the transversal axis 120 of the bottom element 108.

The front frame element 110 defines a leg portion that can be substantially horizontal or tilted downwards from a level of the bottom element 108. The front leg frame element 124 includes a main frame 124A and a secondary frame 124B that is pivotally connected to the main frame 124A. The main frame 124A and the secondary frame 124B can be bracket frames. The secondary frame 124B can function as a support frame in the chair configuration or as a handle in the wagon configuration. The ends of the main frame 124A and a secondary frame 124B that is pivotally connected to the main frame 124A are pivotally connected to the left side frame element 112A and the right-side frame element 112B. The front leg frame element 124 includes a first connector 125A and a second connector 125B that are shown as being disconnected from the arm support frame elements 112A, 112B in the chair configuration. The first connector 125A and the second connector 125B are removable connections that can be attached to the front attachment frame of the arm support frame elements 112A, 112B.

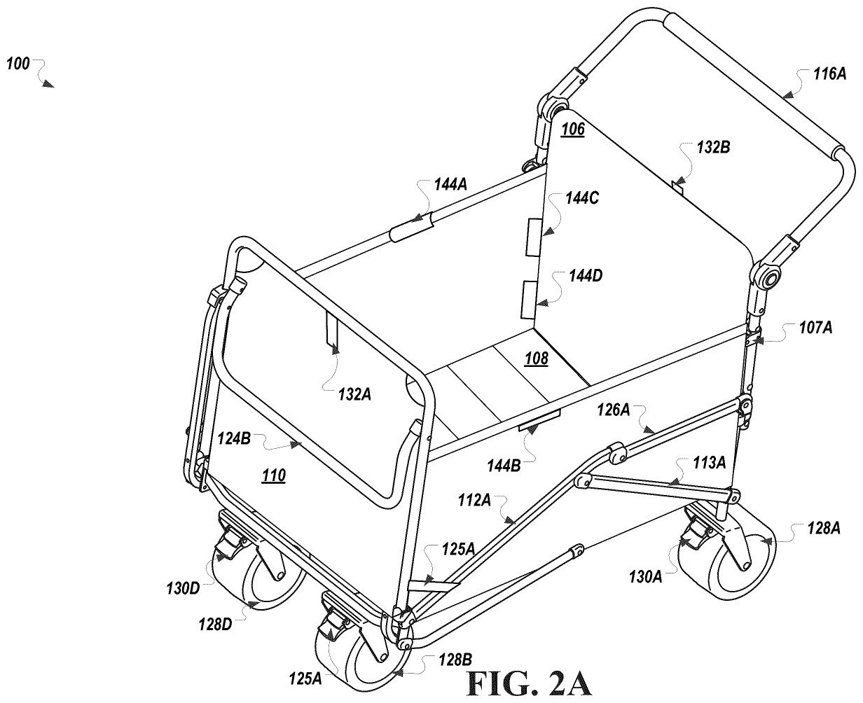

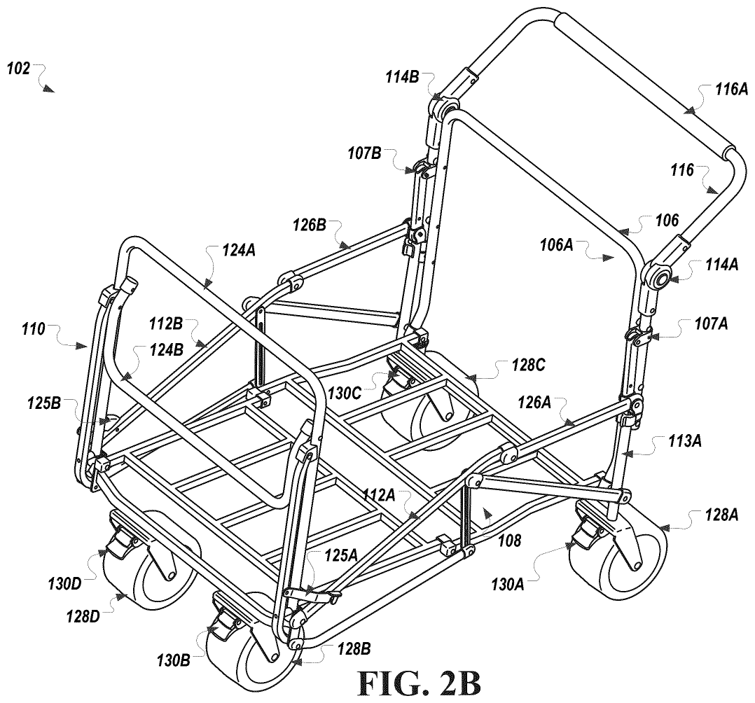

The first side frame element 112A includes a left arm support frame element 126A and the second side frame element 112B includes a right arm support frame element 126B. The left arm support frame element 126A and the right arm support frame element 126B are substantially horizontal in the chair configuration (shown in FIGS. 1A-1D) and the wagon configuration (shown in FIGS. 2A and 2B). In the chair configuration, the first side frame element 112A and the second side frame element 112B are substantially perpendicular to the bottom element 108.

The convertible wagon chair 100 can further include multiple wheels 128A, 128B, 128C, 128D. The wheels 128A, 128B, 128C, 128D can include cardan wheels having large tire treads facilitating support of heavy load and transport (linear movement and rotation) of convertible wagon chair 100 including heavy loads on a variety of terrains, including soft terrains, such as sand or grass, rough terrain, rocky terrain, and terrain with elevation changes. Each of the wheels 128A, 128B, 128C, 128D can include a break 130A, 130B, 130C, 130D to prevent unintended displacement of the convertible wagon chair 100. The convertible wagon chair 100 can further include a strap connector 132 including two portions 132A, 132B and a secure coupler 132C (e.g., buckle). The convertible wagon chair 100 in the chair configuration can have a seating length of about 90 cm to 150 cm. The seating area (e.g., bottom element 108) can have a width of about 20 cm to 70 cm. The convertible wagon chair 100 in the chair configuration can hold up to 200 kg within the bottom element 108 region.

FIG. 1B illustrates the example of the convertible wagon chair frame 102 in a chair configuration having the rear frame element 106 at a first angle 134A, according to some implementations of the present disclosure. FIG. 1C illustrates the example of the convertible wagon chair frame 102 in a chair configuration having the rear frame element 106 at a second angle 134B and having the handle 116 at a first angle 136A, according to some implementations of the present disclosure. FIG. 1D illustrates an example of a convertible wagon chair frame 102 in a chair configuration having the rear frame element 106 at a second angle 134B and having the handle 116 at a second angle 136B, according to some implementations of the present disclosure. The example of the convertible wagon chair frame 102 shown in FIGS. 1B-1D can be similar or identical to the example of the convertible wagon chair frame 102 described with reference to FIG. 1A.

FIGS. 1B-1D show that the rear frame element 106 can be fixed at different angles relative to the bottom element 108 through the expansion of telescopic elements of the reinforced structures 138A, 138B. For example, in the chair configuration, the rear frame element 106 can form an obtuse angle134A, 134B with the bottom element 108 (as shown in FIGS. 1A-1D). In the wagon configuration, the rear frame element 106 can be fixed substantially perpendicular to the bottom element 108 (as shown in FIGS. 2A and 2B) by connecting the coupling elements 107A, 107B to the side frame elements 112A, 112B.

FIGS. 1B-1D also show that the bottom element 108 includes a pair of reinforced structures 138A, 138B. The reinforced structures 138A, 138B are connected to each other at coupling points 140A, 140B in the proximity of the side frame elements 112A, 112B, along the transversal axis 120. The coupling points 140A, 140B enable the reinforced structures 138A, 138B to be fixed in a substantially horizontal plane and to fold relative to each other (as shown in FIGS. 3, 4A, and 4B). The reinforced structures 138A, 138B can include multiple parallel beams 142A-142F that uniformly distribute a load to the bottom element 108 to provide a sturdy support. The parallel beams 142A-142F can be straight angled bars that are permanently attached (e.g., welded) to the margins of the front support frame 108A and of the rear support frame 108B.

FIG. 2A illustrates an example of a convertible wagon chair 100 in a wagon configuration having the fabric 104 covering the frame 102, according to some implementations of the present disclosure. The fabric 104 includes releasable connections 144A, 144B along the margins to attach the fabric 104 to the side frame elements 112A, 112B and detach the fabric 104 for conversion of the wagon into a chair. The fabric 104 covering the side frame elements 112A, 112B forms side portions of the wagon to facilitate transportation of items within the enclosure formed by the wagon. In some implementations, the fabric 104 covering the side frame elements 112A, 112B includes plates that maintain the fabric 104 stretched and provide sturdiness to the respective side. For example, the convertible wagon chair 100 in the wagon configuration can have rigid sides that increase a sturdiness of the bottom element 108, when folded down for the chair configuration.

The fabric 104 includes releasable connections 144C, 144D along the side margins to releasably attach the side portions of the wagon to the rear 106 and front portions 110 of the wagon. The releasable connections 144A, 144B, 144C, 144D include any of snapping elements, hooks and loops fasteners, buckles, magnetic closures, and zippers. The bottom element 108 can have a length of about 70 cm to 100 cm. The bottom element 108 can have a width of about 20 cm to 70 cm. The side frame elements 112A, 112B can provide side stability reducing the risk of falling objects from the wagon when pulling the wagon full. The side frame elements 112A, 112B can have a height of about 20 cm to 50 cm. The convertible wagon chair 100 in the wagon configuration can hold up to 200 kg.

FIG. 2B illustrates an example of a convertible wagon chair frame 102 in a wagon configuration, according to some implementations of the present disclosure. As illustrated in FIGS. 2A and 2B, in the wagon configuration, the rear frame element 106 is fixed substantially perpendicular to the bottom element 108 (as shown in FIGS. 2A and 2B) by connecting the coupling elements 107A, 107B to the side frame elements 112A, 112B, such that the sides 106A, 106B of the rear frame element 106 are parallel and adjacent to the rear support side bars 113 A, 113B of the side frame elements 112A, 112B. One end of each of the coupling elements 107A, 107B can be permanently attached to or coupled to a portion of the convertible wagon chair frame 102, being detachable or disconnectable from the other end. For example, the coupling elements 107A, 107B can be permanently attached to or coupled to the sides 106A, 106B of the rear frame element 106, being detachable from the rear support side bars 113 A, 113B of the side frame elements 112A, 112B.

With continued reference to the wagon configuration, the front frame element 110 is fixed substantially perpendicular to the bottom element 108 (as shown in FIGS. 2A and 2B) by connecting the connectors 125A, 125B to the side frame elements 112A, 112B. The connectors 125A, 125B can include a flat elongated portion and a hook matching dimensions of the inclined elements of the frame elements 112A, 112B to which it attaches. The connectors 125A, 125B can be stainless steel connectors.

As shown in FIG. 2B, the wheels 128A, 128B, 128C, 128D can be connected to the bottom element 108 through a combination of axles, bearings, and suspension systems. For example, a first pair of wheels 128A, 128B can be connected to a front portion of the frame of the bottom element 108. A second pair of wheels 128C, 128D can be connected to a back portion of the frame of the bottom element 108.

FIG. 3 shows an example of a partly folded convertible wagon chair transitioning from a wagon configuration to a folded configuration, according to some implementations of the present disclosure. The convertible wagon chair 100 in a wagon configuration can be folded by a user relatively quickly, and the convertible wagon chair 100 and convertible wagon chair frame 102 can fold into a relatively compact closed or folded configuration. The folding of the convertible wagon chair 100 is facilitated by the hinged connection of multiple portions of the convertible wagon chair frame 102. For example, the bottom element 108 includes a front support frame 108A, including portions 118A, 118B and a rear support frame 108B, including portions 118C, 118D. The front support frame 108A and the rear support frame 108B are hinged substantially in the middle, along the transversal axis 120, at the front end, and rear ends of the base frame. The front end of the bottom element 108 is attached to the front frame element 110 and the rear end of the bottom element 108 is attached to the rear frame element 106.

When a user desires to close or fold the convertible wagon chair 100, the user can initiate the folding operation by manually pulling upwards the pulling element 122 of the bottom element 108, which causes the bottom element 108 to fold in two substantially equal sections, along the transversal axis 120. The folding of the bottom element 108 along the transversal axis 120 triggers connected components of the convertible wagon chair 100 to close and simultaneously gradually fold the convertible wagon chair 100 into a relatively compact closed or folded configuration, as shown in FIGS. 4A and 4B. In the folded configuration, the front frame element 110 folds over the front support frame 108A and the rear frame element 106 folds over the rear frame element 106.

FIG. 4A illustrates an example of a convertible wagon chair 100 in a folded configuration having a fabric covering the frame, according to some implementations of the present disclosure. FIG. 4B illustrates an example of a convertible wagon chair frame 102 in a folded configuration, according to some implementations of the present disclosure. As shown in FIGS. 4A and 4B, the frame 102 of the convertible wagon chair 100 facilitates compact folding. In the compact folded configuration, the sides 106A, 106B of the front frame element 110 can be substantially parallel to the sides of the main frame 124A. In the compact folded configuration, the handle 116A is in an accessible location that facilitates pivotal rotation for maneuvering the convertible wagon chair 100 in the folded configuration. The convertible wagon chair 100 in the folded configuration can have a height of about 50 to 70 cm, a width of about 20 cm to 70 cm and a depth of about 20 cm to 30 cm.

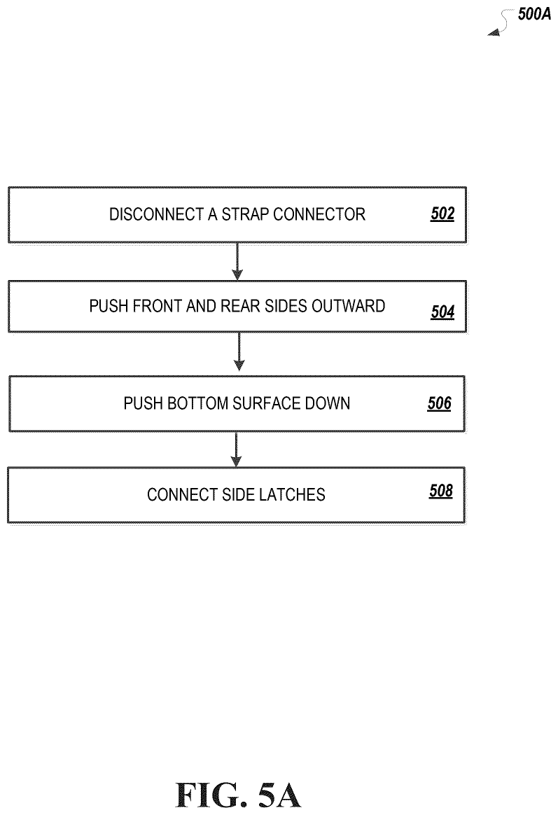

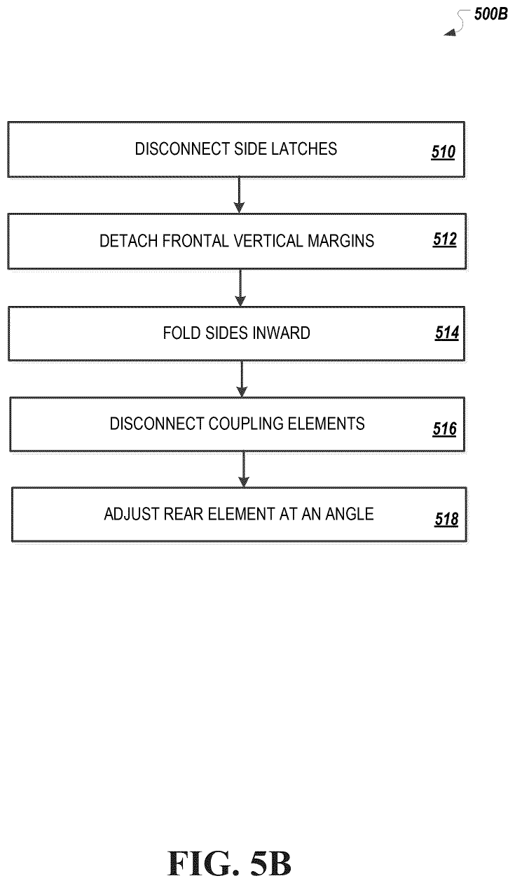

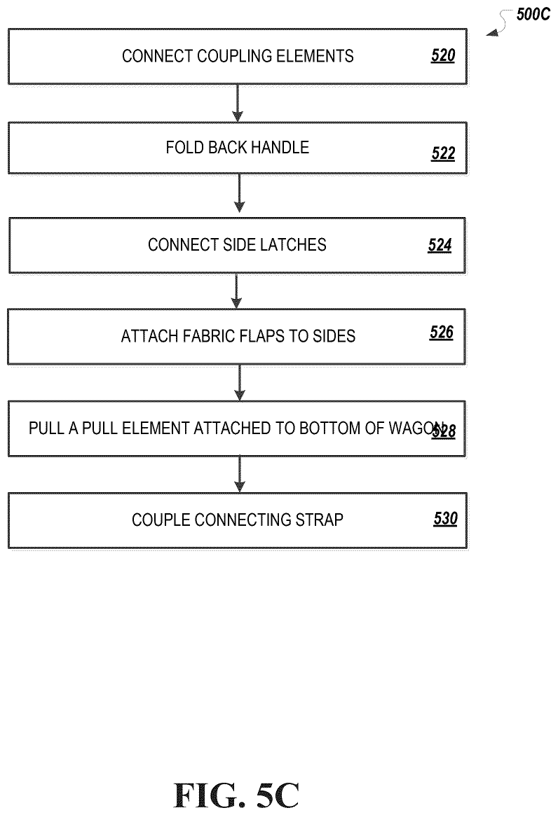

FIG. 5A is a flowchart of an example of a method 500A for opening a folded convertible wagon chair (e.g., folded convertible wagon chair 100, described with reference to FIGS. 4A and 4B) for forming a wagon (e.g., convertible wagon chair 100 in the wagon configuration, described with reference to FIGS. 2A and 2B), according to some implementations of the present disclosure.

At 502, the convertible wagon chair in a folded configuration can be opened by manually releasing a strap connector (e.g., the strap connector 132, described with reference to FIGS. 1A, 2A, and 4A). The release of the strap connector causes a rear frame element (e.g., the rear frame element 106, described with reference to FIGS. 1-4) to unfold away from a front frame element (e.g., the front frame element 110, described with reference to FIGS. 1-4) of the convertible wagon chair.

At 504, the rear frame element (e.g., the rear frame element 106, described with reference to FIGS. 1-4) and the front frame element (e.g., the front frame element 110, described with reference to FIGS. 1-4) of the convertible wagon chair are pushed outward to assist a transition from an oblique orientation to a substantially vertical orientation.

At 506, a bottom element (e.g., the bottom element 108, described with reference to FIGS. 2A, 2B, and 3) is pushed downwards to assist a transition from a partly folded state to a substantially horizontal plane.

At 508, side connectors (e.g., the side connectors 125A. 125B, described with reference to FIGS. 1-4) are connected the side frame elements (e.g., the side frame elements 112A, 112B, described with reference to FIGS. 1-4). The connector connection improves a stability of the wagon configuration, in which the front frame element is fixed substantially perpendicular to the bottom element (as shown in FIGS. 2A and 2B) by connecting the connectors to the side frame elements.

FIG. 5B is a flowchart of an example of a method 500B for forming a chair from a convertible wagon chair in a wagon configuration (e.g., convertible wagon chair 100, described with reference to FIGS. 2A and 2B), according to some implementations of the present disclosure.

At 510, one end of the side connectors is disconnected. For example, the side connectors can be disconnected from the inclined elements of the side frame elements.

At 512, frontal vertical margins are detached to form a front frame element functioning as a leg support. The disconnection of the side connectors and of the releasable connections of the fabric facilitates the front element to transition from a substantially vertical plane to a substantially horizontal plane.

At 514, a second portions of releasable connections are detached, and fabric sides are folded inward over the bottom element. The folding of the fabric sides can increase a stability of the bottom element and a sturdiness of the convertible wagon chair in the chair configuration, to support weight distributed within the bottom element area.

At 516, one end of the coupling elements (e.g., coupling elements 107A, 107B, described with reference to FIGS. 1-4) is disconnected. For example, the coupling elements can be disconnected from the vertical elements of the side frame elements. The disconnection of the coupling elements facilitates the rear frame element to transition from a substantially vertical plane to an inclined plane forming an obtuse angle with the bottom element.

At 518, a rear element is adjusted by extending a telescopic member of the side frame elements to modify an angle between the rear element and the bottom element. In some implementations, a handle included in the rear element is adjusted to provide an additional support for the rear element and prevent tipping of the convertible wagon chair.

FIG. 5C is a flowchart of an example of a method 500C for folding a convertible wagon chair into a folded configuration, according to some implementations of the present disclosure.

At 520, disconnected ends of the coupling elements are connected to the side frame elements. For example, the coupling elements can be connected to the vertical elements of the side frame elements. The connection of the coupling elements facilitates the rear frame element to transition from an inclined plane to a substantially vertical plane forming a substantially straight angle with the bottom element.

At 522, the handle is folded to an angle facilitating maneuvering of the convertible wagon chair.

At 524, disconnected ends of the side connectors are connected to the side frame elements. The side connectors can be attached to the front frame element and can be connectable to the inclined elements of the side frame elements. The connector connection to the side frame elements improves a stability of the convertible wagon chair, keeping the front frame element closely coupled to the bottom element.

At 526, fabric flaps are detached from a bottom element and attached to the side frame elements to form a closed side enclosure. Attaching the fabric flaps to the side frame element can include attaching releasable connections between fabric sides.

At 528, a pulling element attached to the bottom element is pulled upwards to initiate a folding operation. The folding operation causes the bottom element to fold along a transversal axis. The folding of the bottom element triggers connected components of the convertible wagon chair to close and fold the convertible wagon chair into a relatively compact closed or folded configuration, as shown in FIGS. 4A and 4B. At 530, a connecting strap is coupled to keep the convertible wagon chair into a relatively compact closed or folded configuration.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.
Example 1. A convertible wagon, comprising: a frame comprising: a bottom element extensible in a flat configuration and foldable along a transversal section in a folded configuration; a first side frame element; a second side frame element; a front frame element comprising a first connector and a second connector, the first connector connectable to the first side frame element and the second connector connectable to the second side frame element to form a front wagon side in a wagon configuration, the first connector being disconnectable from the first side frame element and the second connector being disconnectable from the second side frame element to form a chair foot support portion at a level of the bottom element in a chair configuration; and a rear frame element connected to the bottom element, the first side frame element, and the second side frame element; and a fabric extending between the front frame element and the rear frame element, wherein sides of the fabric are extensible over the first side frame element and the second side frame element to define lateral wagon sides in the wagon configuration and are foldable over the bottom element in the chair configuration.
Example 2. The convertible wagon of the previous example, wherein the rear frame element comprises a first coupling element connectable to the first side frame element and a second coupling element connectable to the second side frame element to form a rear wagon side in the wagon configuration and a back support portion in the chair configuration, the back support portion in the chair configuration forming a first angle with the bottom element.
Example 3. The convertible wagon of any of the previous examples, wherein the first coupling element is disconnectable from the first side frame element and the second coupling element is disconnectable from the second side frame element to form a second angle between the back support portion in the chair configuration and the bottom element.
Example 4. The convertible wagon of any of the previous examples, wherein the first angle is a substantially straight angle, and the second angle is a substantially obtuse angle.
Example 5. The convertible wagon of any of the previous examples, wherein each of the first coupling element and the second coupling element comprises a hooked end clasping around vertical bars of each of the first side frame element and the second side frame element.
Example 6. The convertible wagon of any of the previous examples, wherein each of the first side frame element and the second side frame element comprises a substantially horizontal bar and an angled bar connected to the substantially horizontal bar and a side margin of the bottom element.
Example 7. The convertible wagon of any of the previous examples, wherein the substantially horizontal bar and the angled bar are pivotably connected to each other to form a substantially obtuse side angle in the chair configuration and in the wagon configuration and to form a substantially acute side angle in the folded configuration.
Example 8. The convertible wagon of any of the previous examples, wherein the bottom element comprises a pulling element for transitioning the convertible wagon from the wagon configuration to the folded configuration.
Example 9. The convertible wagon of any of the previous examples, wherein the fabric comprises releasable connections along the sides to attach the fabric to the first side frame element and to the second side frame element in the wagon configuration and detach the fabric for the chair configuration.
Example 10. The convertible wagon of any of the previous examples, wherein the front frame element comprises a handle in the wagon configuration that functions as a leg in the chair configuration.
Example 11. The convertible wagon of any of the previous examples, wherein the rear frame element comprises a handle in the wagon configuration that functions as a back support leg in the chair configuration.
Example 12. The convertible wagon of any of the previous examples, comprising a strap connector comprising a first portion attached to the front frame element and a second portion attached to the rear frame element, the strap connector comprising the first portion attached to the second portion holding the convertible wagon in the folded configuration, the first portion being detached from the second portion in the chair configuration and in the wagon configuration.
Example 13. The convertible wagon of any of the previous examples, wherein the fabric comprises any of a polyester fabric, a nylon fabric, a polypropylene fabric, an acrylic fabric, textilene fabric and a sunbrella fabric.
Example 14. A method of configuring a convertible wagon, comprising: disconnecting a strap connector of a convertible wagon to transition from a folded configuration to a wagon configuration, the convertible wagon comprising: a frame comprising: a bottom element extensible in a flat configuration and foldable along a transversal section in a folded configuration; a first side frame element; a second side frame element; a front frame element comprising a first connector and a second connector, the first connector connectable to the first side frame element and the second connector connectable to the second side frame element to form a front wagon side in a wagon configuration, the first connector being disconnectable from the first side frame element and the second connector being disconnectable from the second side frame element to form a chair foot support portion at a level of the bottom element in a chair configuration; and a rear frame element connected to the bottom element, the first side frame element, and the second side frame element; and a fabric extending between the front frame element and the rear frame element, wherein sides of the fabric are extensible over the first side frame element and the second side frame element to define lateral wagon sides in the wagon configuration and are foldable over the bottom element in the chair configuration.
Example 15. The method of configuring a convertible wagon of the previous example, comprising: disconnecting a first coupling element of the rear frame element from the first side frame element and disconnecting a second coupling element of the rear frame element from the second side frame element to modify an angle of a back support portion in the chair configuration.
Example 16. The method of configuring a convertible wagon of any of the previous examples, comprising: connecting the first coupling element of the rear frame element to the first side frame element and connecting a second coupling element of the rear frame element to the second side frame element to fix the back support portion in a substantially vertical position.
Example 17. The method of configuring a convertible wagon of any of the previous examples, wherein each of the first coupling element and the second coupling element comprises a hooked end clasping around vertical bars of each of the first side frame element and the second side frame element.
Example 18. A method of configuring a convertible wagon, comprising: disconnecting a first connector and a second connector of a convertible wagon to transition from a wagon configuration to a chair configuration, the convertible wagon comprising: a frame comprising: a bottom element extensible in a flat configuration and foldable along a transversal section in a folded configuration; a first side frame element; a second side frame element; a front frame element comprising the first connector and the second connector, the first connector connectable to the first side frame element and the second connector connectable to the second side frame element to form a front wagon side in the wagon configuration, the first connector being disconnectable from the first side frame element and the second connector being disconnectable from the second side frame element to form a chair foot support portion substantially at a level of the bottom element in the chair configuration; and a rear frame element connected to the bottom element, the first side frame element, and the second side frame element; and a fabric extending between the front frame element and the rear frame element, wherein sides of the fabric are extensible over the first side frame element and the second side frame element to define lateral wagon sides in the wagon configuration and are foldable over the bottom element in the chair configuration.
Example 19. The method of configuring a convertible wagon of the previous example, comprising: disconnecting a first coupling element of the rear frame element from the first side frame element and disconnecting a second coupling element of the rear frame element from the second side frame element to modify an angle of a back support portion in the chair configuration; and connecting the first coupling element of the rear frame element to the first side frame element and connecting a second coupling element of the rear frame element to the second side frame element to fix the back support portion in a substantially vertical position.
Example 20. The method of configuring a convertible wagon of any of the previous examples, wherein each of the first coupling element and the second coupling element comprises a hooked end clasping around vertical bars of each of the first side frame element and the second side frame element.

What is claimed is:

1. A convertible wagon, comprising:
a frame comprising:
a bottom element extensible in a flat configuration and foldable along a transversal section in a folded configuration;
a first side frame element;
a second side frame element;
a front frame element comprising a first connector and a second connector, the first connector connectable to the first side frame element and the second connector connectable to the second side frame element to form a front wagon side in a wagon configuration, the first connector being disconnectable from the first side frame element and the second connector being disconnectable from the second side frame element to form a chair foot support portion at a level of the bottom element in a chair configuration; and
a rear frame element connected to the bottom element, the first side frame element, and the second side frame element; and
a fabric extending between the front frame element and the rear frame element, wherein sides of the fabric are extensible over the first side frame element and the second side frame element to define lateral wagon sides in the wagon configuration and are foldable over the bottom element in the chair configuration.

2. The convertible wagon of claim 1, wherein the rear frame element comprises a first coupling element connectable to the first side frame element and a second coupling element connectable to the second side frame element to form a rear wagon side in the wagon configuration and a back support portion in the chair configuration, the back support portion in the chair configuration forming a first angle with the bottom element.

3. The convertible wagon of claim 2, wherein the first coupling element is disconnectable from the first side frame element and the second coupling element is disconnectable from the second side frame element to form a second angle between the back support portion in the chair configuration and the bottom element.

4. The convertible wagon of claim 3, wherein the first angle is a substantially straight angle, and the second angle is a substantially obtuse angle.

5. The convertible wagon of claim 3, wherein each of the first coupling element and the second coupling element comprises a hooked end clasping around vertical bars of each of the first side frame element and the second side frame element.

6. The convertible wagon of claim 1, wherein each of the first side frame element and the second side frame element comprises a substantially horizontal bar and an angled bar connected to the substantially horizontal bar and a side margin of the bottom element.

7. The convertible wagon of claim 6, wherein the substantially horizontal bar and the angled bar are pivotably connected to each other to form a substantially obtuse side angle in the chair configuration and in the wagon configuration and to form a substantially acute side angle in the folded configuration.

8. The convertible wagon of claim 1, wherein the bottom element comprises a pulling element for transitioning the convertible wagon from the wagon configuration to the folded configuration.

9. The convertible wagon of claim 1, wherein the fabric comprises releasable connections along the sides to attach the fabric to the first side frame element and to the second side frame element in the wagon configuration and detach the fabric for the chair configuration.

10. The convertible wagon of claim 1, wherein the front frame element comprises a handle in the wagon configuration that functions as a leg in the chair configuration.

11. The convertible wagon of claim 1, wherein the rear frame element comprises a handle in the wagon configuration that functions as a back support leg in the chair configuration.

12. The convertible wagon of claim 1, comprising a strap connector comprising a first portion attached to the front frame element and a second portion attached to the rear frame element, the strap connector comprising the first portion attached to the second portion holding the convertible wagon in the folded configuration, the first portion being detached from the second portion in the chair configuration and in the wagon configuration.

13. The convertible wagon of claim 2, wherein the fabric comprises any of a polyester fabric, a nylon fabric, a polypropylene fabric, an acrylic fabric, textilene fabric and a sunbrella fabric.

14. A method of configuring a convertible wagon, comprising:
disconnecting a strap connector of a convertible wagon to transition from a folded configuration to a wagon configuration, the convertible wagon comprising:
a frame comprising:
a bottom element extensible in a flat configuration and foldable along a transversal section in a folded configuration;
a first side frame element;
a second side frame element;
a front frame element comprising a first connector and a second connector, the first connector connectable to the first side frame element and the second connector connectable to the second side frame element to form a front wagon side in a wagon configuration, the first connector being disconnectable from the first side frame element and the second connector being disconnectable from the second side frame element to form a chair foot support portion at a level of the bottom element in a chair configuration; and
a rear frame element connected to the bottom element, the first side frame element, and the second side frame element; and
a fabric extending between the front frame element and the rear frame element, wherein sides of the fabric are extensible over the first side frame element and the second side frame element to define lateral wagon sides in the wagon configuration and are foldable over the bottom element in the chair configuration.

15. The method of configuring a convertible wagon of claim 14, comprising:
disconnecting a first coupling element of the rear frame element from the first side frame element and disconnecting a second coupling element of the rear frame element from the second side frame element to modify an angle of a back support portion in the chair configuration.

16. The method of configuring a convertible wagon of claim 15, comprising:
connecting the first coupling element of the rear frame element to the first side frame element and connecting a second coupling element of the rear frame element to the second side frame element to fix the back support portion in a substantially vertical position.

17. The method of configuring a convertible wagon of claim 15, wherein each of the first coupling element and the second coupling element comprises a hooked end clasping around vertical bars of each of the first side frame element and the second side frame element.

18. A method of configuring a convertible wagon, comprising:
disconnecting a first connector and a second connector of a convertible wagon to transition from a wagon configuration to a chair configuration, the convertible wagon comprising:
a frame comprising:
a bottom element extensible in a flat configuration and foldable along a transversal section in a folded configuration;
a first side frame element;
a second side frame element;
a front frame element comprising the first connector and the second connector, the first connector connectable to the first side frame element and the second connector connectable to the second side frame element to form a front wagon side in the wagon configuration, the first connector being disconnectable from the first side frame element and the second connector being disconnectable from the second side frame element to form a chair foot support portion substantially at a level of the bottom element in the chair configuration; and
a rear frame element connected to the bottom element, the first side frame element, and the second side frame element; and
a fabric extending between the front frame element and the rear frame element, wherein sides of the fabric are extensible over the first side frame element and the second side frame element to define lateral wagon sides in the wagon configuration and are foldable over the bottom element in the chair configuration.

19. The method of configuring a convertible wagon of claim 18, comprising:
disconnecting a first coupling element of the rear frame element from the first side frame element and disconnecting a second coupling element of the rear frame element from the second side frame element to modify an angle of a back support portion in the chair configuration; and
connecting the first coupling element of the rear frame element to the first side frame element and connecting a second coupling element of the rear frame element to the second side frame element to fix the back support portion in a substantially vertical position.

20. The method of configuring a convertible wagon of claim 19, wherein each of the first coupling element and the second coupling element comprises a hooked end clasping around vertical bars of each of the first side frame element and the second side frame element.
